(19) United States
(12) Patent Application Publication
(10) Pub. No.: US 2015/0201230 A1
(43) Pub. Date: Jul. 16, 2015

(54) Using Personal Video Recorder Functionality in a Placeshifting System with Secure Handling of Media Content

(71) Applicant: Philip Drope, Tallahassee, FL (US)

(72) Inventor: Philip Drope, Tallahassee, FL (US)

(21) Appl. No.: 14/672,585

(22) Filed: Mar. 30, 2015

Related U.S. Application Data
(63) Continuation-in-part of application No. 12/959,655, filed on Dec. 3, 2010.
Application No. 12/959,655 is a division of application No. 11/132,771, filed on May 19, 2005, now abandoned.
(60) Provisional application No. 60/572,365, filed on May 19, 2004.

(51) Int. Cl. H04N 21/41; H04N 21/462; H04N 21/4147; H04N 21/258; H04N 21/414; H04N 21/45; H04N 5/76; H04N 21/433; H04N 21/436; H04N 21/6543; H04N 21/2665; H04N 21/4227

(52) U.S. Cl. CPC H04N 21/4135; H04N 21/2665; H04N 21/4622; H04N 21/4147; H04N 21/25841; H04N 21/4227; H04N 21/4524; H04N 5/76; H04N 21/4334; H04N 21/43622; H04N 21/6543; H04N 21/41407

(57) ABSTRACT

Personal video recorder (PVR) functionality is enabled in a placeshifting system which allows a user to find, select, record and then access media programs on a PVR located on various system devices. This functionality can be accomplished by the user from locations which are physically remote from the source of the media programs. This system includes media players and media broadcasting devices. The media players may receive program schedule information and present the program schedule information to the user. Based on user input, the media players identify a media program and associated schedule information. The media players instruct a media broadcasting device to receive the media program; to digitize, encode/decode, transcode, and/or transrate the media program, if necessary; and to transmit the media program to the media players and/or other media broadcasting devices when the media program is scheduled to play. The media program may be recorded in a local storage of the media broadcasting devices or the media players. The media players can also control PVR functionality in various media broadcasting devices and various other media players. The placeshifting system can use digital rights management (DRM) methods to secure media content during its handling and use.

### CROSS REFERENCE TO RELATED APPLICATIONS

This application is a continuation-in-part of U.S. patent application Ser. No. 12/959,655, filed on Dec. 3, 2010, which is a division of U.S. patent application Ser. No. 11/132,771 filed on May 19, 2005, which claims priority of U.S. provisional application Ser. No. 60/572,365 filed on May 19, 2004, each of which are hereby incorporated by reference in their entireties.

### FIELD OF THE INVENTION

This invention relates generally to media applications, and in particular to the secure handling of media programs while transporting and recording media programs using PVR functionality in a placeshifting system.

### BACKGROUND OF THE INVENTION

Video content is no longer constrained to only be consumed at limited locations based upon a receiver location. Instead, video content can be consumed on remote devices such as mobile phones, personal digital assistants (PDAs), and personal video players (PVPs), and portable computers. Through computer networks, as well as other delivery mechanisms, television and other media content are increasingly becoming available on these remote devices. The TV anywhere concept is now being widely adopted. This technology allows users to access their TV content, which was previously only available via a cable or satellite TV subscription, from any geographical location allowed by the content providers. The TV anywhere technology allows access to content across multiple platforms including on the internet, and on remote devices such as smartphones and tablets. The technology described herein helps to expand the possibility of the TV anywhere goal.

As users get more accustomed to video experiences on remote devices, and as mobile storage solutions (e.g., removable flash media and small hard disk drives) become more robust and inexpensive, the desire to add PVR functionality to these devices has emerged. A device with PVR functionality can record video data in digital format on digital storage (e.g., computer memory, hard disk drives). The device with PVR functionality can also provide other control features, such as playback, fast forwarding, rewinding, and pausing, plus the ability to skip to any part of the program without having to rewind or fast forward the data stream.

Traditionally, PVR functionality is implemented in devices, such as set-top boxes, that physically connect to a media source (e.g., cable television, satellite television), store television programs, and transmit the stored programs to an output device, such as a television. However, existing PVR devices are typically stationary, and even if a PVR device could be transported to another location, the media source connected to the PVR device cannot. For example, one could not take a home cable subscription on the road, even if one could theoretically bring a PVR device along. Because a PVR device cannot record programs without a media source providing the media to record, the traditional approach cannot adequately provide PVR functionality in remote devices. Accordingly, there is a need for PVR functionality on remote devices, or devices at a location remote from a media source, to allow users to record and view media programs on those devices.

Another area of concern is the protection of certain content during the transport process due to usage parameters specified by content owners. There is considerable content protection available for consumption at the initial point of reception. Examples are protocols such as High-bandwidth Digital Content Protection (HDCP) and Digital Transmission Content Protection (DTCP). However, there is less content protection for video content being sent from one physical location to another by a user. Therefore, there is a need to for a DRM protocol to reliably and easily protect content during the process of transport to a remote location in a placeshifting system.

### SUMMARY

Embodiments of the invention provide PVR functionality in combination with a placeshifting system to allow users to record media programs from a location remote from the media source. In one embodiment, a media player of a placeshifting system having PVR functionality receives media program schedule information and presents the media program schedule information to its users. Based on a user input (or command), the media player identifies a media program and associated schedule information. When the media program is scheduled to play, the media player requests a media broadcasting device to receive the media program, digitize, encode/decode, transcode, and/or transrate the media program if necessary, and transmit the media program to the media player. The media player records the media program in local storage and presents a notice when the media program is ready to play.

In one embodiment a media player in a placeshifting system having PVR functionality receives schedule information and presents to its users. Based on a user input (or command), the media player identifies a media program and associated schedule information. When the media program is scheduled to play, the media player requests a media broadcasting device to receive the media program, digitize, encode/decode, transcode, and/or transrate the media program if necessary, and transmit to the media player and a second media broadcasting device. The media player and the second media broadcasting device each record the media program in local storage and the media player presents a notice when the media program is ready to play.

In one embodiment a media player receives schedule information and presents the schedule information to its users. Based on a user input (or command), the media player identifies a media program and associated schedule information, and gives instructions to a media broadcasting device to record the media program in local storage (e.g., PVR) when it is scheduled to play. The media player later requests the media broadcasting device to retrieve the media program from the local storage and digitize, encode/decode, transcode, and/or transrate the media program if necessary, and transmit to the media player to the user for viewing.

In one embodiment a media player receives a media program or video from a source local to the media player and stores the media program and/or video on a local storage of the media player. For example, a video could be a locally received media program or a video of vacation activities. Then, based on a user input (or command), the media player retrieves the video from the local storage and then proceeds to digitize, encode/decode, transcode, and/or transrate the media program if necessary, and transmits it to a media broadcasting device for storage on the PVR of the media broadcasting device. The video could also be a live video stream which is sent directly, with the help of a buffer, to the media broadcasting device for storage on the media broadcasting device PVR. To reduce the computing demand on the media player, some of the tasks for modification of the video signal could be done by the media broadcasting device before the video is stored on the PVR. For example, the media broadcasting device may transcode and/or transrate the video.

In one embodiment, a media player in a placeshifting system having PVR functionality receives schedule information and presents the schedule information to its users. Based on a user input (or command), the media player identifies a media program and associated schedule information. A chosen media program may comprise, for example, protected content, and requires handling by a DRM management system. A media broadcasting device and a media player can perform required valid device verification prior to the scheduled time for the media program. When the media program is scheduled to play, the media player requests a media broadcasting device to receive the media program, digitize, encode/decode, transcode, and/or transrate, and encrypt the media program if necessary, and transmits the media program to the media player. The media player receives the media program and decrypts it using the DRM management system of the media player. Then, the media program is viewed by the user on the media player. The media player also has the option of saving the media program in encrypted or decrypted form on the PVR of the media player.

In one embodiment, the media player recovers from transmission interruptions of the media program and resumes the transmission and recording of the media program. In another embodiment, the media player adjusts the data flow rates of the streaming media program in real time, based upon network and/or buffer conditions to assure optimum quality of the media program being received for viewing and/or recording. In another embodiment, the media player adjusts the transmission and recording of the media program to reduce the impacts on other tasks performed by the remote device, where the media player is located.

### BRIEF DESCRIPTION OF THE DRAWINGS

FIG. 1 is a block diagram of a computing environment for recording media programs in a placeshifting system, in accordance with an embodiment of the invention.

FIG. 2 is a block diagram of an expanded computing environment for recording media programs in a placeshifting system, in accordance with an embodiment of the invention.

FIG. 3 is a block diagram illustrating the architecture of a remote device, in accordance with an embodiment of the invention.

FIG. 4 is a block diagram illustrating modules within a media player illustrated in the environment of FIG. 1, in accordance with an embodiment of the invention.

FIG. 5 is a flowchart of a process for a method of recording a media program in a placeshifting system illustrated in the environment of FIG. 1, in accordance with an embodiment of the invention.

FIG. 6 is a flowchart of a process for an alternate method of recording a media program in a placeshifting system illustrated in the environment of FIG. 2, in accordance with an embodiment of the invention.

FIG. 7 is a block diagram illustrating the data flow for an alternate method of recording a media program in a placeshifting system illustrated in the environment of FIG. 2, in accordance with an embodiment of the invention.

FIG. 8 is a flowchart of a process for an alternate method of recording a media program in a placeshifting system illustrated in the environment of FIG. 1, in accordance with an embodiment of the invention.

FIG. 9 is a block diagram illustrating the data flow for a digital rights management (DRM) method for media content transport from the media broadcasting device and the media player illustrated in the environment of FIG. 1, in accordance with an embodiment of the invention.

FIG. 10 is a block diagram illustrating an alternate data flow for a digital rights management (DRM) method for media content transport from the media broadcasting devices and the media player illustrated in the environment of FIG. 2, in accordance with an embodiment of the invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

Embodiments of the invention provide PVR functionality in placeshifting systems for users to record media programs from locations that are physically remote from media sources. A media player may display schedule information for media programs that are available at a media source. A user identifies a media program in the media player. The media player requests a media broadcasting device to receive the media program from the media source and transmit to the media player. The media player records the media program received from the media broadcasting device and presents a notice to the user.

According to various embodiments, the media player requests a first media broadcasting device to receive the media program from the media source and transmit the media program to the media player and a second media broadcasting device. The media player and second media broadcasting device record the media program received from the first media broadcasting device. The media player or second media broadcasting device then presents a notice to the user of the availability of the requested media program.

The media player requests a media broadcasting device to receive the media program from the media source, record the media program on the media broadcasting device, and transmit the media program to the media player and record on the media player. The media player then presents a notice to the user of the availability of the requested media program and gives user the option of recording media program and/or viewing the media program live.

A DRM system is implemented which allows secure encrypted transport of a protected media program between placeshifting devices. The protected media program may be decrypted and made available to the user at the receiving device(s). One embodiment shown is the secure transport of a protected media program from a media broadcaster to a media player based upon a request from the media player. A second embodiment shown is the secure transport of a protected media program from a first media broadcaster to a second media broadcaster based upon instructions from the media player.

As used herein, a media program may include any type of media content, including audio or video content, or both. The media program may be either live or recorded and may be streamed or downloaded.

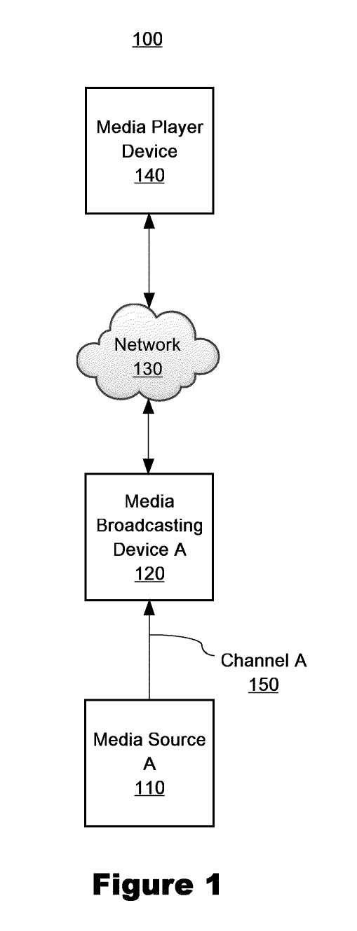

FIG. 1 is a block diagram of a computing environment 100 for recording media programs in a placeshifting system according to one embodiment of the invention. As illustrated, the computing environment 100 includes a media source A 110, a media broadcasting device A (hereinafter called broadcaster A) 120, and a media player device (hereinafter called media player) 140. The media source A 110 is communicatively connected to the broadcaster A 120 through a channel A 150. The broadcaster A 120 and the media player 140 are communicatively connected through a network 130.

The media source A 110 includes hardware and/or software devices that are configured to transmit media content to the broadcaster A 120. Examples of the media source A 110 include a cable set-top box, a satellite set-top box, a radio receiver, a digital camera, a tuner (e.g., a cable tuner), a DVD/VCD/VHS player, a time-shifting device (e.g., a PVR), and a computer. The media source A 110 may provide services such as video on demand and pay-per-view, as may be appreciated.

The media source A 110 may retrieve media content from a local storage (e.g., a DVR, DVD) or receive it from a remote source (e.g., a remote computer server). The media source A 110 may receive the media content through a variety of pathways, including, but not limited to, the following: over the air via analog or digital RF transmission; Internet protocol (IP) transmission delivered over a wired/wireless network and satellite transmission.

In one embodiment, the media source A 110 receives a radio frequency signal (RF signal) from a broadcast station (i.e., a source broadcaster) such as a radio station or a television station. Because an RF signal may include a number of video and/or audio signals modulated therein, the media source A 110 may filter the RF signal for a selected channel, demodulate the channel, and convert the signal into separate analog video and/or audio signals.

The broadcaster A 120 includes hardware and/or software devices that are configured to receive media content from the media source A 110 through the channel A 150 and transmit media content to the media player 140 through the network 130. In one embodiment, the broadcaster A 120 may digitize encode/decode, transcode and/or package the media content before sending it to the media player 140. In one embodiment, the broadcaster A 120 may be a media broadcasting device of a placeshifting system (e.g., a multimedia server of a multimedia network system). The broadcaster A 120 may receive media content from multiple media sources (not shown). In one embodiment, the media player 140 is a media player of a placeshifting system (e.g., a multimedia client of a multimedia network system).

A placeshifting system includes, at least, a media broadcasting device and a media player. Using a placeshifting system, a user can watch or listen to live, recorded, or stored media on a remote device via a data network. For example, a user may stream content from a media broadcasting device at home (such as a satellite receiver, cable box, or digital video recorder) to a media player (such as an application executing on a cellular phone), which can receive the media from across the house, across town, or across the world. This transmission may use public and/or private networks.

In one embodiment, the broadcaster A 120 may convert received media content from one media format to another format, or perform any other transcoding, encoding/decoding, transrating, digitization (such as converting media content from analog form to digital form), or other processing on received media content as desired.

The broadcaster A 120 may transmit media content to the media player 140 responsive to a request from the media player 140. Alternatively, the broadcaster A 120 may transmit the media content to the media player 140 using content delivery mechanisms such as push technology (e.g., server push or web casting). As suggested by its name, the broadcaster A 120 may transmit the media content to multiple devices, such as a HDTV, a VCR, a projector, and one or more media players 140. In one embodiment, the broadcaster A 120 transmits media content as one or more media streams. A media stream may be sent as a series of small packets. The broadcaster A 120 may send the media stream using common network protocols (e.g., Internet protocol, user datagram protocol).

In one embodiment, the broadcaster A 120 may receive commands and operate according to the commands. For example, a command may direct the broadcaster A 120 to switch to a specific channel, convert media content to a specific format (e.g., high-definition resolution video), and/or transmit a media program to a specific device using a network protocol. A media player 140 may transmit the commands to the broadcaster A 120 through the network 130. In one embodiment, the broadcaster A 120 authorizes a device before accepting commands from the device and/or operating according to commands from the device. The authorization may be part of a DRM system or the requirement that the user provide validation by logging into a device with a password or key.

The media player 140 includes hardware and/or software devices that are configured to receive and record media content from the broadcaster A 120 through the network 130. Regarding software, the media player 140 can be, for example, one or more applications executing within one or more operating systems on a remote device. The remote device may be a general purpose computer (e.g., a mobile computer, a personal digital assistant (PDA)) or a mobile communication device (e.g., a mobile phone). Regarding hardware, the media player can be a special purpose device such as a personal video player (PVP) or digital media player with network capability.

In one embodiment, the media player 140 may provide schedule information for media programs to be broadcasted by a source broadcaster or available at the media source A 110, and/or receive user inputs identifying media programs intended to be recorded on the media player 140. The media player 140 may retrieve the schedule information from the broadcaster A 120 or an electronic programming guide (EPG) service provider. The media player 140 may generate commands based on the user inputs and the schedule information and transmit the commands to the broadcaster A 120, instructing the broadcaster A 120 to transmit the identified media programs to the media player 140.

The network 130 represents the communication pathways between the broadcaster A 120 and the media player 140. The network 130 may be a wired or wireless network. Examples of the network 130 include the Internet, an intranet, a cellular network, or a combination thereof.

The channel A 150 is the delivery pathway through which the media source A 110 transmits the media content to the broadcaster A 120. The channel A 150 may be a wired or wireless cable connection (e.g., A/V cable, monitor cable, and the like). In one embodiment, the channel A 150 may be located completely within a device, such as where the broadcaster A 120 is on the same device as the media source A 110.

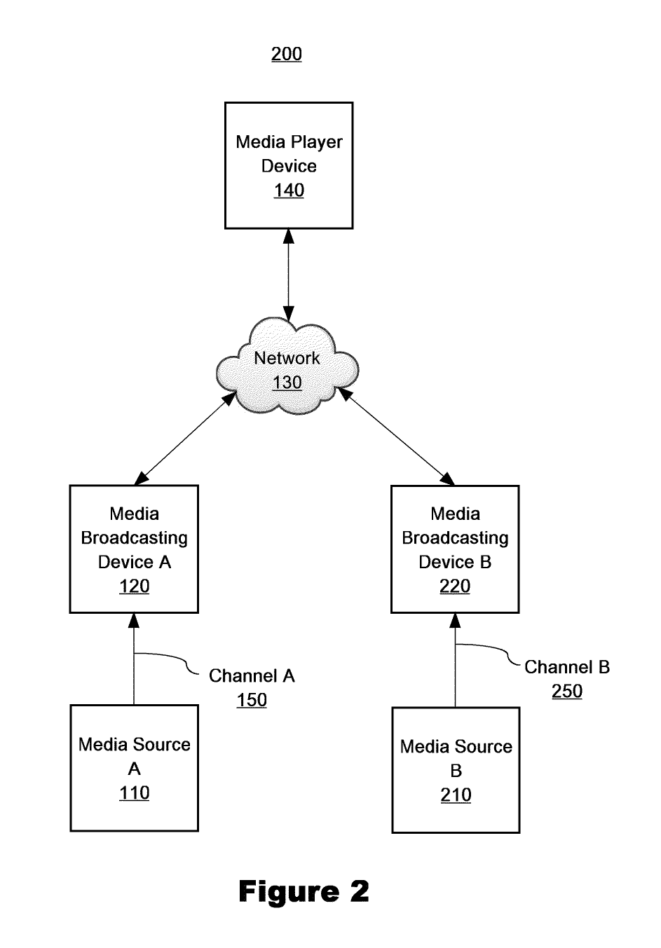

FIG. 2 is a block diagram of an expanded computing environment 200 for recording media programs in a placeshifting system according to one embodiment of the invention. As illustrated, the expanded computing environment 200 includes a media source A 110, a media broadcasting device A (broadcaster A) 120, and a media player 140. The media source A 110 is communicatively connected to the broadcaster A 120 through a channel A 150. The broadcaster A 120 and the media player 140 are communicatively connected through a network 130. The expanded computing environment 200 also includes a media source B 210, a media broadcasting device B (hereinafter called broadcaster B) 220. The media source B 210 is communicatively connected to the broadcaster B 220 through a channel B 250. The broadcaster B 220 and the media player 140 are communicatively connected through a network 130. The broadcaster A 120 and broadcaster B 220 are communicatively connected through the network 130.

The media source A 110 includes hardware and/or software devices that are configured to transmit media content to the broadcaster A 120. Examples of the media source A 110 include a cable set-top box, a satellite set-top box, a radio receiver, a digital camera, a tuner (e.g., a cable tuner), a DVD/VCD/VHS player, a time-shifting device (e.g., a PVR), and a computer. The media source A 110 may provide services such as video on demand or pay-per-view.

The media source A 110 may retrieve media content from a local storage (e.g., a DVR, DVD) or receive it from a remote source (e.g., a remote computer server). The media source A 110 may receive the media content through a variety of pathways, including, but not limited to, the following: over the air via analog or digital RF transmission; Internet protocol (IP) transmission delivered over a wired/wireless network and satellite transmission.

In one embodiment, the media source A 110 receives a radio frequency signal (RF signal) from a broadcast station (i.e., the source broadcaster) such as a radio station or a television station. Because an RF signal may include a number of video and/or audio signals modulated therein, the media source A 110 may filter the RF signal for a selected channel, demodulate the channel, and convert the signal into separate analog video and/or audio signals.

The broadcaster A 120 includes hardware and/or software devices that are configured to receive media content from the media source A 110 through the channel A 150 and transmit media content to the media player 140 through the network 130. In one embodiment, the broadcaster A 120 may digitize encode/decode, transcode and/or package the media content before sending it to the media player 140. In one embodiment, the broadcaster A 120 may be a media broadcasting device of a placeshifting system (e.g., a multimedia server of a multimedia network system). The broadcaster A 120 may receive media content from multiple media sources (not shown).

The media source B 210 includes hardware and/or software devices that are configured to transmit media content to the broadcaster B 220. Examples of the media source B 210 include a cable set-top box, a satellite set-top box, a radio receiver, a digital camera, a tuner (e.g., a cable tuner), a DVD/VCD/VHS player, a time-shifting device (e.g., a PVR), and a computer. The media source B 210 may provide services such as video on demand or pay-per-view.

The media source B 210 may retrieve the media content from a local storage (e.g., a DVR, DVD) or receive it from a remote source (e.g., a remote computer server). The media source B 210 may receive the media content through a variety of pathways, including, but not limited to, the following: over the air via analog or digital RF transmission; Internet protocol (IP) transmission delivered over a wired/wireless network and satellite transmission.

In one embodiment, the media source B 210 receives a radio frequency signal (RF signal) from a broadcast station (the source broadcaster) such as a radio station or a television station. Because an RF signal may include a number of video and/or audio signals modulated therein, the media source B 210 may filter the RF signal for a selected channel, demodulate the channel, and convert the signal into separate analog video and/or audio signals.

The broadcaster B 220 includes hardware and/or software devices that are configured to receive media content from the media source B 210 through the channel B 250 and transmit the media content to the media player 140 through the network 130. In one embodiment, the broadcaster B 220 may digitize encode/decode, transcode and/or package the media content before sending it to the media player 140. In one embodiment, the broadcaster B 220 may be a media broadcasting device of a placeshifting system (e.g., a multimedia server of a multimedia network system). The broadcaster B 220 may receive media content from multiple media sources (not shown). In one embodiment, the media player 140 is a media player of a placeshifting system (e.g., a multimedia client of a multimedia network system).

In one embodiment, the broadcaster A 120 and broadcaster B 220 are located in a same physical location. The media player 140, or other properly designated system devices, can search the recorded media content of broadcaster A 120 and broadcaster B 220 individually or as a single location for recorded media content. The media player 140, or other properly designated system devices, can access the recorded media content of broadcaster A 120 and broadcaster B 220. The media player 140, or other properly designated system devices, can control the recording schedule of broadcaster A 120 and broadcaster B 220 individually. As will be described later, recorded media content can be distributed between broadcaster A 120 and broadcaster B 220 to optimize the memory storage space that is available on each broadcaster and in the placeshifting system. Although the media programs that are available from media source A 110 and media source B 210 may be very similar, if not identical, each broadcaster could be used for storage and/or viewing of specific media content such as video on demand or pay-per-view. In one embodiment, recorded or live media content on broadcaster A 120 or broadcaster B 220 can be streamed to the other broadcaster or the media player 140 at the request of the user.

In one embodiment, the broadcaster A 120 and broadcaster B 220 may convert the received media content from one media format to another format and/or perform any other transcoding, encoding/decoding, transrating, digitization (such as converting media content from analog form to digital form), or other processing on received media content as desired.

The broadcaster A 120 and broadcaster B 220 may transmit media content to the media player 140 responsive to a request from the media player 140. Alternatively, the broadcaster A 120 and broadcaster B 220 may transmit the media content to the media player 140 using content delivery mechanisms such as push technology (e.g., server push or web casting). As suggested by its name, the broadcaster A 120 and broadcaster B 220 may transmit the media content to multiple devices, such as a HDTV, a DVR, a projector, and one or more media players 140. In one embodiment, the broadcaster A 120 and broadcaster B 220 transmit media content as one or more media streams. A media stream may be sent as a series of small packets. The broadcaster A 120 and broadcaster B 220 may send the media stream using common network protocols (e.g., Internet protocol, user datagram protocol).

In one embodiment, the broadcaster A 120 and broadcaster B 220 may receive commands and operate according to the commands. For example, a command can direct the broadcaster A 120 and broadcaster B 220 to switch to a specific channel, convert media content to a specific format (e.g., high-definition resolution video), and/or transmit a media program to a specific device using a network protocol. A media player 140 may transmit the commands to the broadcaster A 120 and broadcaster B 220 through the network 130. In one embodiment, the broadcaster A 120 and broadcaster B 220 authorize a device before accepting commands from the device and/or operating according to commands from the device.

The media player 140 includes hardware and/or software devices that are configured to receive and record media content from broadcaster A 120 and broadcaster B 220 through the network 130. Regarding software, the media player 140 can be, for example, one or more applications executing within one or more operating systems on a remote device. The remote device may be a general purpose computer (e.g., a mobile computer, a personal digital assistant (PDA)) or a mobile communication device (e.g., a mobile phone). Regarding hardware, the media player 140 can be a special purpose device such as a personal video player (PVP) or digital video player with network capability.

In one embodiment, the media player 140 may provide schedule information for media programs to be broadcasted by the source broadcaster or available at the media source A 110 and media source B 210, and/or receive user inputs identifying media programs intended to be recorded on the media player 140. The media player 140 may retrieve the schedule information from the broadcaster A 120, broadcaster B 220 or an EPG service provider. The media player 140 may generate commands based on the user inputs and the schedule information and transmit the commands to the broadcaster A 120 and broadcaster B 220, instructing the broadcaster A 120 and broadcaster B 220 to transmit the identified media programs to the media player 140.

The network 130 represents the communication pathways between the broadcaster A 120 and broadcaster B 220 and the media player 140. The network 130 may be a wired or wireless network. Examples of the network 130 include the Internet, an intranet, a cellular network, or a combination thereof.

The channel A 150 and channel B 250 are the delivery pathways through which the media source A 110 and media source B 210 transmits the media content to the broadcaster A 120 and broadcaster B 220. The channel A 150 and channel B 250 may be a wired or wireless cable connection (e.g., A/V cable, monitor cable, and the like). In one embodiment, the channel A 150 may be completely within a device, such as where the broadcaster A 120 is on the same device as the media source A 110. In one embodiment, the channel B 250 may be completely within a device, such as where the broadcaster B 220 is on the same device as the media source B 210.

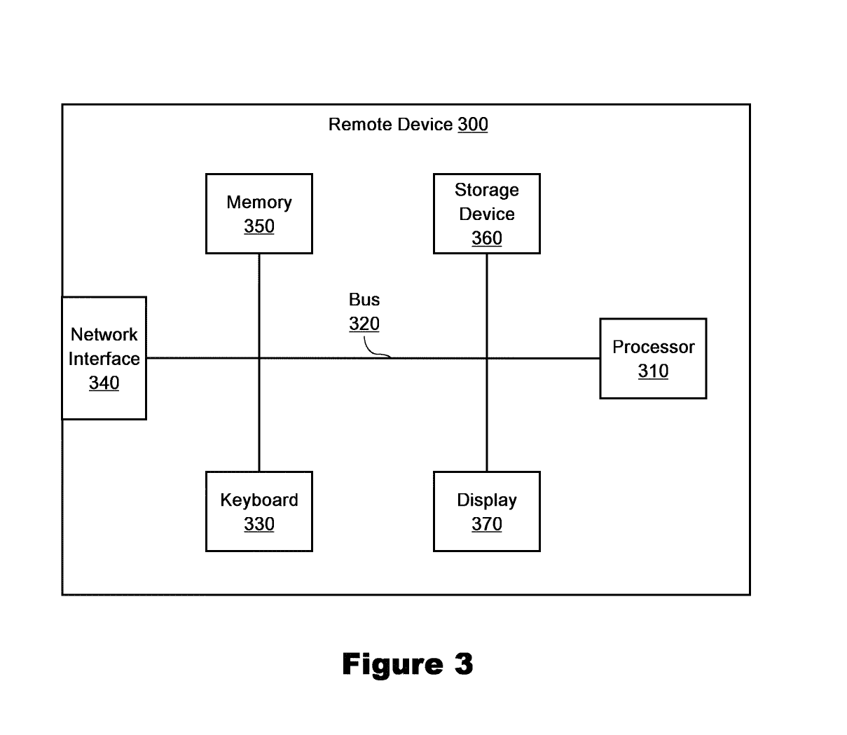

Referring to FIG. 3, there is shown a block diagram illustrating the architecture of a remote device 300 executing the media player 140 as illustrated in the computing environment 100 of FIG. 1 according to an embodiment of the invention and as illustrated in the expanded computing environment 200 of FIG. 2 according to another embodiment of the invention. As shown, the remote device 300 includes a processor 310 coupled to a bus 320. Also coupled to the bus 320 are a keyboard 330, a network interface 340, a memory 350, a storage device 360, and a display 370.

The processor 310 may be any general-purpose or application-specific processor. A portion of the bus 320 may be isolated from the remainder of the bus 320 to allow for the secure handling of content being handled during the DRM control process. The storage device 360, in one embodiment, is a hard disk drive or any other device capable of storing data, such as a solid-state memory device (e.g., flash memory). The memory 350 may be, for example, firmware, read-only memory (ROM), non-volatile random access memory (NVRAM), and/or RAM, and holds instructions and data used by the processor 310. The network interface 340 couples the remote device 300 to the network 130. The bus 320 is an electrical conductor that serves as an electrical pathway along which signals are sent from components connected to the bus. The display 370 may be an output screen on which visual information is displayed. The display 370 may be a touch-sensitive screen which users can interact with the media player 140 by touching the display 370. The keyboard 330 may be a standard keypad for touch-tone telephones, a QWERTY keyboard, or any other type of input device. In many instances, the remote device 300 lacks one or more of the elements shown in FIG. 3, such as the keyboard 330. In one embodiment, the remote device 300 may contain a media player of a placeshifting system (e.g., a multimedia client of a multimedia network system).

As is known in the art, the remote device 300 is adapted to execute computer program modules (or programs). As used herein, the term “module” refers to computer program logic and/or data for providing a specified functionality. A module can be implemented in hardware, firmware, and/or software. In one embodiment, the modules are stored on the storage device 360, loaded into the memory 350, and executed by the processor 310.

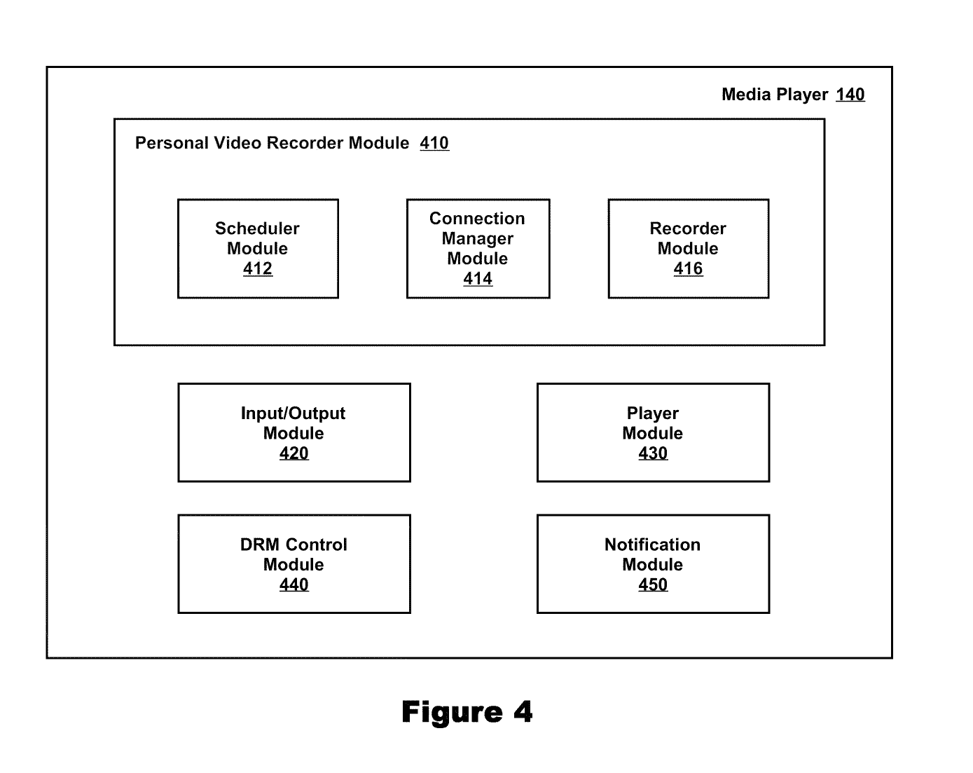

FIG. 4 is a block diagram illustrating the modules of the media player 140 according to an embodiment of the invention. Other embodiments have additional and/or different modules than the ones shown in the figure. In addition, functionalities can be distributed among the modules in a manner different than described here. Further, some of the functions can be provided by entities other than the media player 140. As illustrated in FIG. 4, the media player 140 includes a PVR module (also may be referenced as a remote client application) 410, an input/output module 420, a player module 430, a DRM control module 440 and a notification module 450.

The PVR module 410 is designed to provide PVR functionality for the media player 140. The PVR module 410 includes a scheduler module 412, a connection manager module 414 and a recorder module 416. All or portions of the PVR module 410 can reside on, or function in cooperation with, the broadcaster A 120 and broadcaster B 220, the remote device 300, and/or an intermediate device. For example, the scheduler module 412 and the connection manager module 414 may reside on the remote device 300, while the recorder module 416 may be located on the broadcaster A 120, broadcaster B 220 and/or an intermediate device.

The scheduler module 412 is configured to provide users of the media player 140 with schedule information of the media programs to be broadcasted by the source broadcaster or available at the media source A 110 and/or media source B 210. For example, the scheduler module 412 may display a list of television programs that is available from one or multiple television stations and/or cable television providers of the media source A 110 and/or media source B 210. The scheduler module 412 may retrieve the scheduling information from an EPG service provider. Alternatively, the scheduler module 412 may retrieve the schedule information from external sources (e.g., the media source A 110 and/or media source B 210 and/or broadcaster A 120 and/or broadcaster B 220) or local storage (e.g., the storage device 360). In one embodiment, the scheduler module 412 may enable a user to conduct searches in the schedule information for media programs.

The scheduler module 412 is also configured to receive user inputs identifying the media program for recording. The user may select one, a series of, or a portion of a media program as presented in the schedule information. The user may make the selection through the input/output module 420. In one embodiment, the scheduler module 412 may accept user inputs identifying a media program without presenting the schedule information. For example, the user may learn about a media program's schedule from an online media guide or a social media post and input the schedule information to the scheduler module 412 to identify the media program. The user may also input other information related to the media recording. For example, if the user would like to watch a television show as soon as it becomes available, the user may select the show for recording and assign a high priority to it. As another example, the user may set the scheduler module 412 to record media programs on another device (e.g., the broadcaster A 120, broadcaster B 220, additional media players). In yet another example, the user may conduct an interactive search to find recorded media programs located on various system devices and/or upcoming media programs based upon user provided search criteria.

The scheduler module 412 translates the user inputs into a set of commands that can be executed in the broadcaster A 120 and broadcaster B 220. For example, the user inputs may include the scheduled starting date and time, duration, channel number, preferred format of a television program, and a preferred transmission mechanism. The corresponding set of commands include commands for switching channel, commands for setting the starting time, commands for converting the television program into the preferred format, and commands for transmitting the converted television program to the media player 140 (or some other devices) using the preferred transmission mechanism.

The scheduler module 412 transmits the set of commands to the broadcaster A 120 or broadcaster B 220. In one embodiment, the scheduler module 412 maintains a schedule calendar including all the media programs selected for recording. When a selected media program is scheduled to play, the scheduler module 412 transmits the corresponding set of commands to the broadcaster A 120 or broadcaster B 220 so that it transmits the media program to the media player 140 (or some other devices) or records the media program locally. Alternatively, the scheduler module 412 may transmit the set of commands to the broadcaster A 120 or broadcaster B 220 before the scheduled time of the associated media program. The broadcaster A 120 or broadcaster B 220 may schedule the transmission of the associated media program to the media player 140 (or some other devices) according to these commands.

The connection manager module 414 is configured to establish connections with the broadcaster A 120 or broadcaster B 220 using the network interface 340. The connection establishment may be initiated by the connection manager module 414 or the broadcaster A 120 or broadcaster B 220. In one embodiment, the connection manager module 414 may detect the network protocols (or communication protocols) supported by the network interface 340, and use a supported network protocol to establish the connection with the broadcaster A 120 or broadcaster B 220. The connection manager module 414 may engage in an authorization process with the broadcaster A 120 or broadcaster B 220 to obtain permission to transmit commands to the broadcaster A 120 or broadcaster B 220 and/or to accept media programs from the broadcaster A 120 or broadcaster B 220. The connection manager module 414, in cooperation with the DRM control module 440, may also engage in an authorization process with the broadcaster A 120 or broadcaster B 220 to obtain and view protected media content from the broadcaster A 120 or broadcaster B 220.

The recorder module 416 is configured to record media programs in local storages. Depending on the location of the recorder module 416, it may record the media programs in storages of the remote device 300, the broadcaster 120, or an intermediate device. As described above with reference to the broadcaster 120 in FIG. 1, the broadcaster 120 may transmit the media program as a media stream in a series of small packets. The recorder module 416 may record the media program as these packets arrive.

The notification module 418 is configured to issue various notifications within the placeshifting system. These notifications can include a notice indicating that a media program is recorded and ready for users to interact with, a phone call is incoming or that there is a problem with the network connectivity. For example, the notification module 418 may display a message on the display 370 of the media player 140 stating that a television program is ready for viewing. The notification module 418 may also present notices before a media program is fully recorded. For example, if a user indicated a high priority for a scheduled radio program, the notification module 418 may present a notice to the user as soon as the broadcaster 120 starts transmitting the radio program to the media player 140. This allows the user to listen to the radio program in real time (or near real time). The notification module 318 allows user to choose notification method. Among those methods are email, posting to a web page, audible, vibrate, silent or text. Each device within the placeshifting system can contain a notification module to allow information to be exchanged throughout the system.

The input/output module 420 is configured to receive user inputs and present output information (e.g., media programs, schedule information, and notices) on the media player 140. The input/output module 420 may receive user inputs via input devices such as the keyboard 330, a touch-sensitive screen, a microphone, and a camera. The input/output module 420 may output information via output devices such as the display 370. In one embodiment, the input/output module 420 may output the media program to an external device such as a speaker, a monitor, and a projector.

The player module 430 is configured to play media programs received from the broadcaster 120 or locally recorded media programs. The player module 430 may also be configured to provide other control features, such as playback, fast forwarding, rewinding, and pausing, plus the ability to skip to any part of the recorded media programs without having to rewind or fast forward the data stream on the media player 140. In one embodiment, the player module 430 may play the media program while the recorder module 416 is recording it or other media programs.

In one embodiment, the broadcaster A 120, broadcaster B 220 and various other system devices may contain some of the same modules described for the media player 140. For instance, the PVR functionality described, the notification functionality and DRM functionality could be available within any placeshifting system device. This allows considerable flexibility and efficiency in the handling of various tasks based upon processor capabilities, availability of secure computing environments, memory storage space available, network throughput conditions, network protocols available and several other placeshifting system parameters not mentioned here.

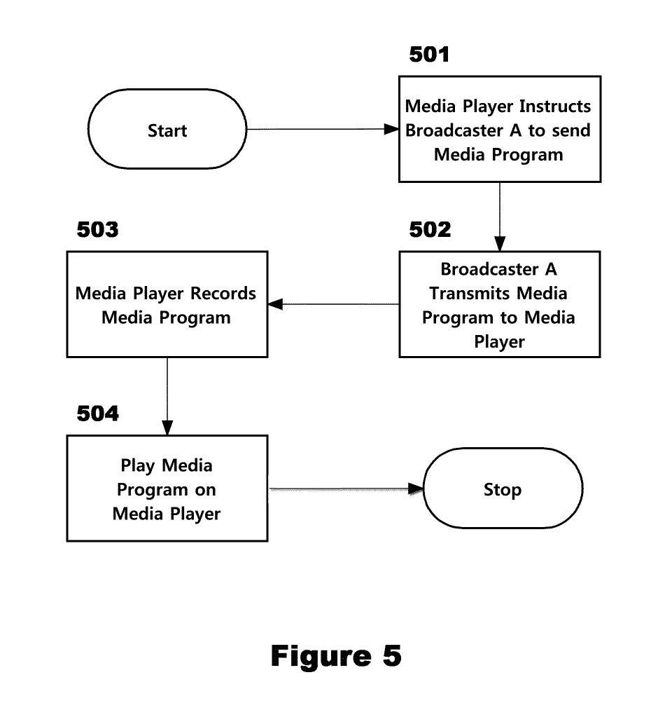

FIG. 5 is a flowchart of an exemplary process for recording a media program in a placeshifting system in accordance with another embodiment of the invention. This process may be implemented in software, hardware, or a combination of hardware and software.

The process illustrated in FIG. 5 starts when the media player 140 instructs broadcaster A 120 to send a media program in step 501. The broadcaster A 120 tunes the media source A 110 to the right input source and converts the media program stream to a format acceptable by the media player 140 (or other device(s) identified by the user). In step 502 the broadcaster A 120 transmits the media program to the media player 140 in a data stream. The media player 140 then records the requested media program in step 503. At step 504 the user instructs the media player 140 to play the recorded media program.

In one embodiment, a media player 140 receives a media program or video from a source local to the media player 140 and stores that video on the media player 140 local storage (PVR). For example, this video could be a locally received media program or video of vacation activities or video of the search for a new home. Then, based on a user input (or command), the media player 140 retrieves the video from the media player 140 PVR and then proceeds to digitize, encode/decode, transcode, and/or transrate the media program if necessary, and transmit it to the broadcaster A 120 for storage on the PVR of broadcaster A 120. This video could also be a live video stream which is sent directly, with the help of buffering, to the broadcaster A 120 for storage on the broadcaster A 120 PVR. To reduce the computing demand on the media player 140, some of the tasks for modification of the video signal could be done by the broadcaster A 120 before storage on the PVR. This transfer would allow another family member to view the vacation video or home search video stored on the broadcaster A 120 using another media player 140 located either locally or remote to the broadcaster A 120.

It should be noted that substitution of broadcaster B 220 for broadcaster A 120 in the discussions above would have no effect on the embodiment except for the different media programs available from media source A 110 and media source B 210.

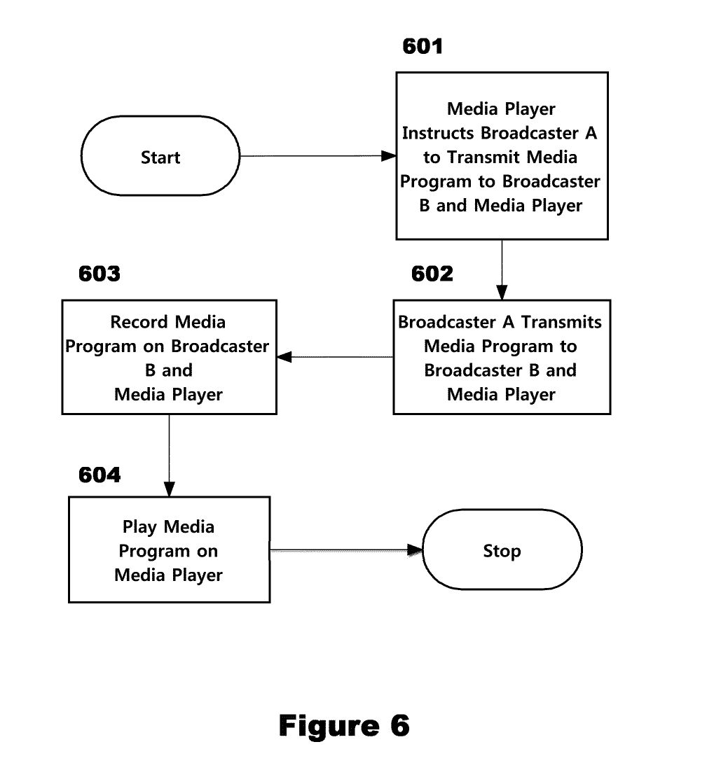

FIG. 6 is a flowchart of an exemplary process for recording a media program in a placeshifting system in accordance with another embodiment of the invention. This process may be implemented in software, hardware, or a combination of hardware and software.

The process illustrated in FIG. 6 starts with the media player 140 instructing the broadcaster A 120 to transmit a media program for recording on broadcaster B 220 and the media player 140 in step 601. The user network includes a second broadcaster B 220. The broadcaster B 220 is at a different physical location from broadcaster A 120 and the media player 140. Broadcaster B 220 is connected to media source B 210 which allows access to a different set of media programs than broadcaster A 120. The broadcaster A 120, at step 602, tunes the media source A 110 to the right input source and converts the media program stream to a format acceptable by the media player 140 (or other device(s) identified by the user), and transmits the converted media program to media player 140 and broadcaster B 220 in a data stream. At step 603 the media player 140 and broadcaster B 220 record the incoming media program. At step 604 the user requests the media program recorded on the media player 140 be made available for viewing.

The broadcaster A 120 and broadcaster B 220 could be located in different regions of the country or on totally different continents. For this reason the media programs available, such as news, weather, sports and entertainment, could be very different and diverse. One may have access to premium cable or satellite programs while the other may have limited service. One may be a primary home while the second may be a vacation home. In one embodiment, a media player 140 could request broadcaster A 120 to send several media programs to broadcaster B 220 in preparation for an upcoming vacation. This could be done before the vacation to minimize concerns about network congestion. The media player 140 or broadcaster A 120 could send a notification when the transfer is completed. The user could then connect to broadcaster B 220 to assure that the transfers were successful.

In one embodiment, a media player 140 could instruct broadcaster A 120 or broadcaster B 220 to send several media programs to the media player 140 for storage on the media player 140 PVR. These media programs can then be viewed while traveling, even in environments where no networks are available or they are very limited, such as aircraft or rural areas. In one embodiment, a Wi-Fi network at a residence could allow a media player 140 installed in a vehicle to instruct broadcaster A 120 or broadcaster B 220 to send several media programs to the media player 140 for storage on the media player 140 PVR. These media programs can then be viewed by passengers while traveling in the vehicle without a concern for network connectivity or congestion.

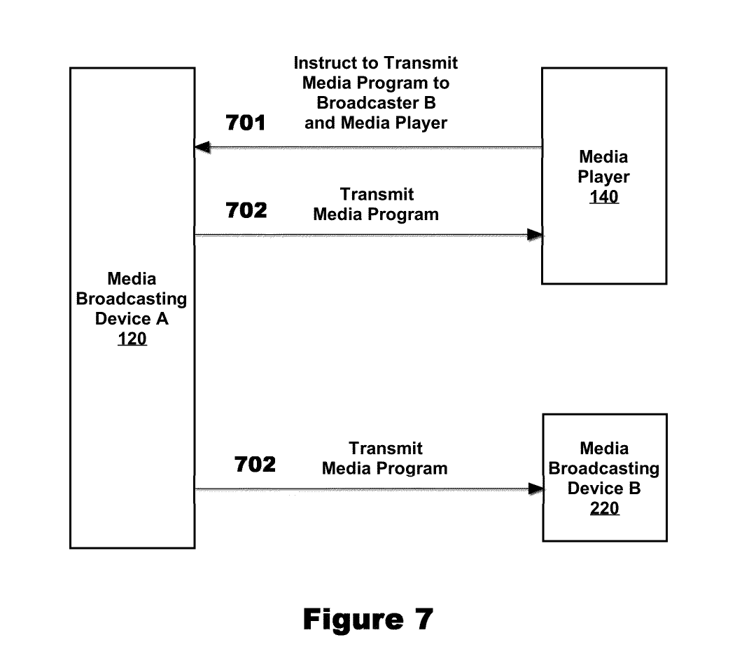

FIG. 7 is a block diagram of an exemplary process for the data exchange steps for receiving a media program and recording that media program in a placeshifting system in accordance with one embodiment of the invention. This process may be implemented in software, hardware, or a combination of hardware and software.

The process illustrated in FIG. 7 starts when the media player 140 requests a media program to be sent from the broadcaster A 120 to media player 140 and broadcaster B 220 for recording in step 701. In step 702, the broadcaster A 120, tunes the media source A 110 to the right input source and converts the media program stream to a format acceptable by the media player 140 (or other device(s) identified by the user), and transmits the converted to media player 140 and broadcaster B 220 in a data stream. The media player 140 and broadcast B 220 then record the requested media program. The instructions for broadcaster B 220 to record media program (not shown) may come indirectly from the broadcaster A 120 or directly from media player 140.

In one embodiment, when broadcaster A 120 is instructed to receive and/or record a media program at a specific time and it is determined that broadcaster A 120 is not available at that time the placeshifting system can provide the option to record the media program on broadcaster B 220 or another broadcaster which can record the same media program. This flexibility allows access to a media program even when it is not available on the first broadcaster of choice.

In one embodiment, the media player 140 is in the same physical enclosure as another device such as a television and the broadcaster A 120 can transmit the media program directly to the television.

It should be noted that swapping of broadcaster B 220 and broadcaster A 120 in the discussions above would have no effect on the embodiment except for the different media programs available from media source A 110 and media source B 210.

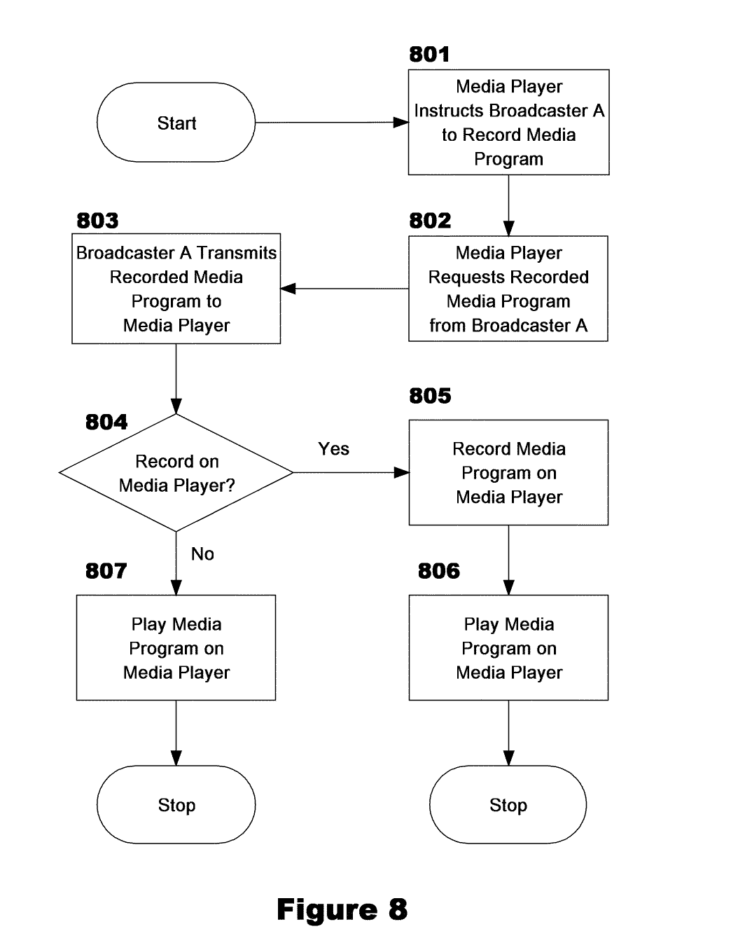

FIG. 8 is a flowchart of an exemplary process for recording a media program in two locations in a placeshifting system in accordance with one embodiment of the invention. This process may be implemented in software, hardware, or a combination of hardware and software.

The process illustrated in FIG. 8 starts with the media player 140 instructing the broadcaster A 120 to record a media program, in step 801. The broadcaster A 120 tunes the media source A 110 to the right input source and records the media program on a storage device (e.g., PVR) associated with the broadcaster A 120. At step 802 the media player 140 instructs the broadcaster A 120 to send the previously recorded media program. The broadcaster A 120, at step 803, retrieves the media program from the storage device, converts the media program to a format acceptable by the media player 140 (or other device(s) identified by the user), and transmits the converted program to the media player 140 in a data stream. At step 804 the user decides if they would like to record and play the media program on the media player 140. If the user choses to record and play then at step 805 the media player 140 begins recording the media program in a local storage device (e.g. the storage device 360) and at step 806 the user begins playing the media program on the media player 140. If the user choses to only play the media program then at step 807 the user begins playing the media program on the media player 140. In both cases, with the help of buffering, the user can begin playing the media program immediately upon the beginning of the transmission of the media program from the broadcaster A 120 to the media player 140 in a data stream.

In one embodiment, the media player 140 transmits the set of commands to the broadcaster A 120 when the identified media program is scheduled to be transmitted by the media source A 110, requesting the broadcaster A 120 to start receiving the media program from the media source, digitize, encode/decode, transcode, and/or transrate the media program if necessary, and transmit the content of the media program to the media player 140 in a data stream. In another embodiment, the set of commands may request the broadcaster A 120 to request the media source A 110 to switch to the right channel so that the media source A 110 receives and transmits the identified media program to the broadcaster A 120 for storage on a local storage device (e.g., PVR).

As is described in greater detail below, the broadcaster A 120 may transmit the media program to the media player 140 as it receives the program from the media source A 110. Alternatively, the broadcaster A 120 may transmit the media program over time, thereby minimizing the impact on other operations of the media player 140. For example, the remote device 300 may be a smartphone, and the user may use the phone to make phone calls while the media player residing on the phone is receiving and recording the media program in the background. When there are interruptions in the transmission of the media program (e.g., lost cellular network connectivity), the broadcaster A 120 may subsequently resume the transmission from where the previously interrupted transmission left off. In one embodiment, the placeshifting system adjusts the data flow rates of the streaming media program in real time based upon network and/or buffer conditions. In one embodiment, the media player may receive the data stream from an intermediate device (e.g., an on-network storage device) instead of the placeshifting device. In one embodiment, the media player adjusts the data flow rates of the streaming media program in real time based upon network and/or buffer conditions.

The media player 140 may present a notice to the user when the selected media program is recorded and/or ready for viewing. For example, the media player may generate and display a message identifying the media program and indicating its status (e.g., “your requested episode of CSI has just been received and is ready for viewing”). The user may thereafter decide to play the media program offline. As another example, the media player 140 may populate a listing of the recorded media programs available to the user, thereby allowing the user to browse the list of recorded programs and select one for viewing. In another embodiment, the user can select to play a media program while it is recorded by the media player 140.

In one embodiment, the media player 140 transmits the set of commands to the broadcaster A 120 when the identified media program is scheduled to be transmitted by the media source 110, requesting the broadcaster A 120 to start receiving the media program from the media source, digitize, encode/decode, transcode, and/or transrate the media program if necessary, and transmit the content of the media program to the media player 140 in a data stream. In another embodiment, the set of commands may request the broadcaster A 120 to request the media source A 110 to switch to the right channel so that the media source A 110 receives and transmits the identified media program to the broadcaster A 120. Depending on how the PVR module 410 is distributed (e.g., between the broadcaster A 120 and the media player 140) and configured, the media program may be recorded in the broadcaster A 120, the media player 140, or some other devices accessible through the network 130.

Alternatively, the user can input the schedule information of the media program, such as the time and channel into the media player 140. The user can also provide other information such as priority and video quality of the recording. For example, the user can instruct the media player 140 to notify the user as soon as the identified media program is ready to view. As another example, the user can instruct the media player 140 to record an identified video program in high quality so that the user can play the video program in a HDTV. The user can make the selection and/or input using input devices such as a keyboard and a touch-sensitive screen of the media player 140.

In another embodiment, the user can input the user command via a different interface such as a webpage on a different device such as a computer connected to a network. The web server hosting the webpage can transmit the user command to the media player 140, broadcaster A 120 or other system devices through the network 130.

In one embodiment, the media player 140 can instruct broadcaster A 120 to add to or modify the recording schedule for the PVR associated with the broadcaster A 120. This is very helpful when away from home and needing to check, modify or add to the recording schedule.

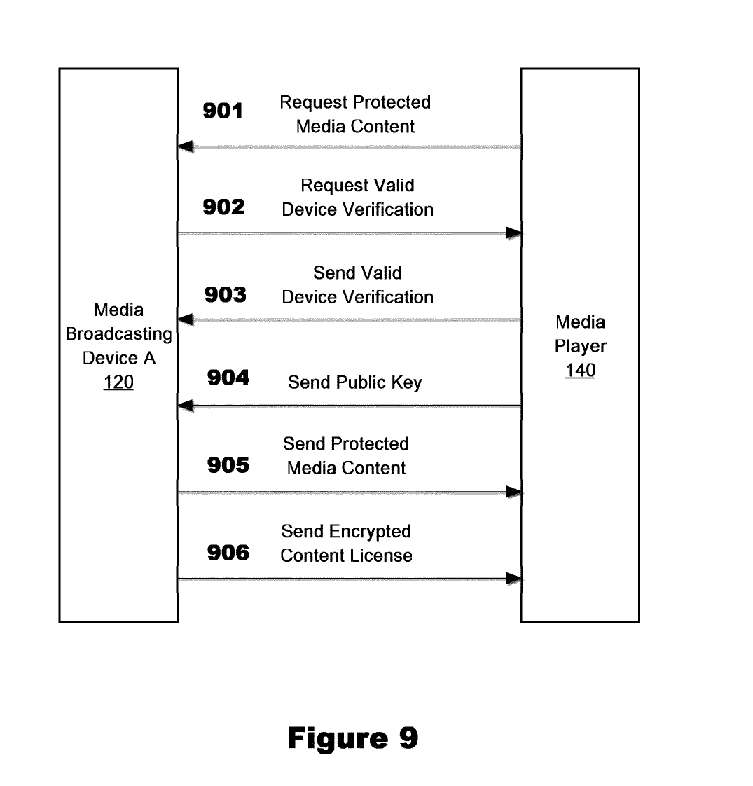

FIG. 9 is a block diagram of an exemplary process for the data exchange steps for a digital rights management (DRM) method for transport of protected media content within the placeshifting system. This process may be implemented in software, hardware, or a combination of hardware and software.

The process illustrated in FIG. 9 starts when the media player 140 requests protected media content from the broadcaster A 120 in step 901. In step 902 the broadcaster A 120 requests a valid device verification from the media player 140. A valid device verification is sent from the media player 140 to the broadcaster A 120 in step 903.The media player 140 then sends a public key associated with the media player 140 to the broadcaster A 120 in step 904. In step 905 the broadcaster A 120 transmits the protected media program to the media player 140 in a data stream. The broadcaster A 120 encrypts a content license using the public key associated with the media player 140 and sends to the the media player 140 in step 906. The media player 140 can then record the encrypted media content on a storage location (e.g., storage device 360) on the remote device and also decrypt and view the media program as described below.

The goal of the DRM method is to protect the media program from use by unauthorized parties. To accomplish this end the media program is encrypted during transport and only decrypted upon its arrival in a secure area of the media player 140. The content license, comprising a content key which the media player 140 can use to decrypt the protected media content and usage parameters specifying terms under which the protected media content can be consumed, is decrypted using a private key associated with the media player 140. The user can then enjoy the media program on the media player 140 according to the terms specified in the content license. The content usage parameters are typically established by the content provider. Even though the placeshifting system allows for usage of the content at a different physical location the usage allowed would be the same as the original location.

In one embodiment, the content usage parameters are embedded within the protected media content and only the content key is included within the content license. In this case, the usage parameters are handled differently in the DRM system but usage parameters are still applied by the receiving device to control how the protected media content is to be consumed.

It should be noted that substitution of broadcaster B 220 for broadcaster A 120 in the discussions above would have no effect on the embodiment. Any of these combinations would allow for the secure transport and use of the protected media content when applying the DRM protocol described.

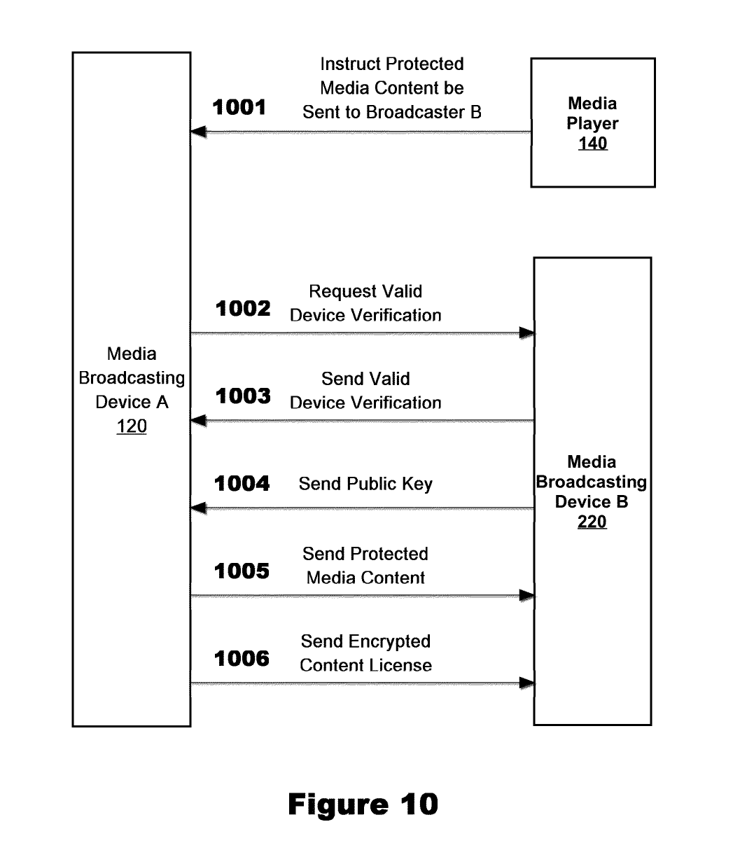

FIG. 10 is a block diagram of an exemplary process for the data exchange steps for a digital rights management (DRM) method for transport of protected media content within the placeshifting system. This process may be implemented in software, hardware, or a combination of hardware and software.

The process illustrated in FIG. 10 starts when the media player 140 requests protected media content from the broadcaster A 120 to be sent to broadcaster B 220 for recording in step 1001. In step 1002 the broadcaster A 120 requests a valid device verification from the broadcaster B 220. A valid device verification is sent from the broadcaster B 220 to the broadcaster A 120 in step 1003.The broadcaster B 220 then sends a public key associated with the broadcaster B 220 to the broadcaster A 120 in step 1004. In step 1005 the broadcaster A 120 transmits the protected media program to the broadcaster B 220 in a data stream. The broadcaster A 120 encrypts a content license using the public key associated with the broadcaster B 220 and sends to the broadcaster B 220 in step 1006. The broadcaster B 220 can then record the encrypted media content on a storage location associated with the broadcaster B 220 (e.g., PVR). The recorded media content can then be streamed to a media player 140, located either locally or remotely, from the broadcaster B 220 as described in FIG. 9 for viewing using the DRM methods described below.

As previously stated, the goal of the DRM method is to protect the media program from use by unauthorized parties. To accomplish this end the media program is encrypted during transport and only decrypted upon its arrival in a secure area of the media player 140. The content license, comprising a content key which the media player 140 can use to decrypt the protected media content and usage parameters specifying terms under which the protected media content can be consumed, is decrypted using a private key associated with the media player 140. The user can then enjoy the media program on the media player 140 according to the terms specified in the content license. The content usage parameters are typically established by the content provider. Even though the placeshifting system allows for usage of the content at a different physical location the usage allowed would be the same as the original location.

Some of the advantages of moving the protected media content from the broadcaster A 120 to the broadcaster B 220 are the closer proximity to the media player 140, which could improve the network conditions, and also the possibility of conserving storage space at the broadcaster A 120 location by sharing all PVR storage available to the placeshifting system.

Media programs may be transmitted using different communication protocols (or network protocols) and/or networks. The broadcaster A 120, broadcaster B 220 and the media player 140 may support multiple communication protocols (e.g., Ethernet, WiMAX, WAN, Wi-Fi, and Bluetooth) and may communicate through multiple networks. The broadcaster A 120 and broadcaster B 220 may transmit media programs using one or more communication protocols and/or networks.

In one embodiment, the media player 140 may send commands to the broadcaster A 120 or broadcaster B 220, instructing it to use a particular communication protocol and/or network. Therefore, users of the media player 140 may set rules indicating their preferences among the communication protocols and/or networks. For example, a user may set a rule instructing the broadcaster A 120 or broadcaster B 220 to use Ethernet, not Wi-Fi, to transmit media programs when both communication protocols are available. Users may also set restrictions for a communication protocol and/or network. For example, a user may prohibit the broadcaster A 120 or broadcaster B 220 from transmitting media programs using a cellular network between 6 AM and 9 PM. Users may also specify a particular communication protocol for the transmission. For example, a user may set a low priority for a media program, requiring the broadcaster A 120 or broadcaster B 220 to transmit the media program to a cellular phone overnight during non-peak hours so that the media program is available to the user for offline viewing on the cellular phone the following day.

The media player 140 may receive and record media programs in the background (i.e., while actively conducting other operations or tasks). For example, depending on the capability of the remote device 300 executing the media player 140, a user may use the remote device 300 to make phone calls, to send and/or receive emails or short messages, to browse the Internet, or to listen to music while the media player 140 is receiving and recording media programs from the broadcaster A 120 or broadcaster B 220. In one embodiment, the connection manager module 414 adjusts the transmission of the media programs so that the other tasks are not affected (or affected minimally) by the transmission and recording. For example, when detecting that the user is initiating a phone call, the connection manager module 414 may temporarily halt (or suspend) the transmission, switch the transmission from using the cellular network to using another network, or decrease the transmission rate. As a result, the media program transmission and recording may be accomplished over time and not interfere with other operations of the remote device 300 and/or the media player 140.

In one embodiment, the broadcaster A 120 or broadcaster B 220 may record (or cache) a media program (or a portion thereof) temporarily in a local (built-in or removable) storage after the transmission of the media program has been interrupted. The transmission may be interrupted (e.g., the network 130 may become temporarily unavailable) or slowed down (e.g., the media player 140 and/or the device 200 executing the media player 140 may be busy performing other tasks). Therefore, the broadcaster A 120 or broadcaster B 220 may record the media program (or a portion thereof) received from the media source A 110 or media source B 210 in local storage to prevent it from being lost. Once a connection between the broadcaster A 120 or broadcaster B 220 and the media player 140 is reestablished, the transmission of the media program can resume, taking into consideration the point at which the previously interrupted transmission left off.

As explained above with respect to FIGS. 4 and 8, depending on how the PVR module 410 is distributed and configured, the media program may be recorded by the broadcaster A 120 or broadcaster B 220 in a local storage or an intermediate device (e.g., an on-network storage device such as a personal computer, a network access server, or a storage area network). The intermediate device may provide PVR functionality to the media player 140. When a user wants to access the media programs from the media player 140, the broadcaster A 120 or broadcaster B 220 may act as an arbiter between the media player 140 and the intermediate device by retrieving the media programs from the intermediate device and encoding/decoding, transcoding and/or transrating the content if necessary before repackaging and streaming it to the media player 140. Alternatively, the media player 140 may access the intermediate device directly. For example, the broadcaster A 120 or broadcaster B 220 may be instructed to transmit media programs to a laptop computer (the intermediate device). The media player 140 may subsequently (or concurrently) retrieve the media programs from the laptop computer through a local network (e.g., Bluetooth, Wi-Fi).

One of skill in the art will recognize that the method described above can be used in a number of circumstances or applications. For example, it can be used to provide time-shifting functionality on a placeshifting system to record audio and/or video programs.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices.

Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

Therefore, what is claimed is:

1. A method for recording media programs in a placeshifting device for playback at a remote device in communication with the placeshifting device via a network, comprising:
receiving a first instruction from the remote device via the network that identifies a media program to be recorded at the placeshifting device;
receiving the media program identified in the first instruction from a media source at the placeshifting device;
recording the media program on a storage associated with the placeshifting device;
receiving a second instruction via the network from the remote device for playback of the media program recorded on the storage associated with the placeshifting device; and
providing, in response to the second instruction, the media program recorded on the storage associated with the placeshifting device to a media player via the network.

2. The method of claim 1, further comprising:
providing a schedule of programming information that identifies the media program to the remote device via the network.

3. The method of claim 2, wherein the schedule of programming information is provided from a web server identifying a media program to be recorded.

4. The method of claim 1, wherein the media source is connected to the placeshifting device, and wherein the placeshifting device controls the media source in the receiving of the media program identified in the first instruction.

5. The method of claim 1, wherein the media program is recorded in response to the first instruction.

6. The method of claim 1, further comprising:
presenting, in response to the media program being recorded, a notice indicating that the media program is recorded.

7. The method of claim 1, wherein the remote device comprises at least one selected from a group consisting of: a mobile phone, a personal digital assistant, a mobile computer, and a personal video player.

8. The method of claim 1 further comprising temporarily suspending the providing of the media program recorded on the storage associated with the placeshifting device to the playback device when the playback device executes another task.

9. A method to record media programs received from a placeshifting device at a remote device via a network, the method comprising:
receiving a user input at the remote device, wherein the user input identifies a media program to be recorded;
directing, via the user input, the placeshifting device to obtain the identified media program from a media source;
receiving the identified media program from the placeshifting device at the remote device via the network;
adjusting, in response to the remote device performing another task, the receiving of the media program to reduce an impact on performing the other task;
recording the received media program in a local storage at the remote device; and
playing back the media program recorded in the local storage by the remote device.

10. The method of claim 9, wherein the adjusting the receiving of the media program comprises transmitting a command from the remote device to the placeshifting device.

11. The method of claim 9, wherein receiving the media program from the placeshifting device comprises:
responding to an interruption during the receiving of the media program by reestablishing the receiving of the media program from where previously uninterrupted receiving left off.

12. The method of claim 11 further comprising, after the reestablishing, receiving at least a portion of the media program that was recorded by the placeshifting device during the interruption.

13. The method of claim 9, wherein the directing comprises generating a command responsive to the user input that directs a broadcaster to obtain the identified media program from the media source and to transmit the obtained media program to the remote device when the media program is broadcast.

14. The method of claim 9, wherein the adjusting of the receiving of the media program comprises suspending the receiving of the media program from the placeshifting device.

15. The method of claim 9, wherein the adjusting of the receiving of the media program comprises changing a communication protocol used to receive the media program over the network.

16. The method of claim 9, wherein the adjusting of the receiving of the media program comprises receiving the media program using a different network.

17. The method of claim 9, wherein the adjusting of the receiving of the media program comprises receiving the media program at a lower transmission rate.

18. The method of claim 10, wherein the command from the remote device to the placeshifting device directs the placeshifting device to suspend transmitting of the media program to the remote device.

19. The method of claim 10, wherein the command from the remote device to the placeshifting device directs the placeshifting device to transmit the media program using a different communication protocol.

20. The method of claim 10, wherein the command from the remote device to the placeshifting device directs the placeshifting device to transmit the media program using a different network.

21. The method of claim 10, wherein the command from the remote device to the placeshifting device directs the placeshifting device to transmit the media program at a lower transmission rate.

22. A system for recording media programs received via a network from a placeshifting device, the system comprising:
a user input device configured to receive a user input identifying a media program available from the placeshifting device;
an interface to the network; and
a media player module configured to:
receive the identified media program from the placeshifting device via the interface;
playback the received media program; and
adjust, in response to the system performing another task, the receiving of the media program to thereby reduce impacts on performing the other task.

23. The system of claim 22, wherein the media player module is further configured to reestablish the receiving of the media program from where the previously interrupted receiving left off responding to an interruption of receiving the media program, wherein a broadcaster records at least a portion of the media program responding to the interruption, and transmits the recorded portion to a remote device responding to a reestablishment of a connection with the remote device.

24. The system of claim 22, further comprising a local storage, and wherein the media player module is further configured to store the identified media program in the local storage for subsequent playback.

25. The system of claim 22, wherein the other task comprises handling a telephone call, and wherein the media player is configured to adjust the receiving of the media program by suspending receipt through a duration of the telephone call.

26. The system of claim 22, wherein the remote device system is implemented as at least one selected from a group consisting of: a mobile phone, a personal digital assistant, a mobile computer, and a personal video player.

27. The system of claim 22, wherein the media player is further configured to adjust the receiving of the media program by suspending receiving of the media program for a duration of the other event.

28. The system of claim 22, wherein the media player is further configured to adjust the receiving of the media program by receiving the media program using a different communication protocol.

29. The system of claim 22, wherein the media player is further configured to adjust the receiving of the media program by receiving the media program using a different network.

30. The system of claim 22, wherein the media player is further configured to adjust the receiving of the media program by receiving the media program at a lower transmission rate.
